(19) United States
(12) Patent Application Publication
(10) Pub. No.: US 2006/0066269 A1
(43) Pub. Date: Mar. 30, 2006

(54) Control apparatus

(75) Inventors: Jack Broomfield Lumley, Preston, Lancashire (GB); Emma Susan Reynolds, Preston, Lancashire (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems pic, London (GB)

(21) Appl. No.: 10/533,905

(22) PCT Filed: Apr. 25, 2005
(86) PCT No.: PCT/GB05/50055

§ 371 Date: May 5, 2005

(30) Foreign Application Priority Data
Apr. 27, 2004 (GB) 04093498
Apr. 27, 2004 (EP) 042524330

(51) Int. Cl. H02K 41/00; H02P 7/00

(52) U.S. Cl. 318/135

(57) ABSTRACT

A control apparatus comprising a movable control member, a positional servo loop consisting of a motor having a movable armature thereby maintaining the position of the control member at any one of a plurality of positions in a range of movement thereof in accordance with a demand signal, and means for detecting a force applied to the control member and for providing the demand signal which varies in accordance with the magnitude of the applied force, wherein the control member is rigidly attached to the armature so that movement of the control member is precisely mirrored by movement of the armature. The force is detected by measuring the current applied to the motor (which is proportional to the force). Direct drive of the control member eliminates backlash from the system.

This invention relates to a control apparatus and in particular, but not exclusively, to a throttle box for controlling an aircraft engine. The invention extends more widely to any control apparatus in which a movable control member exerts a control function.

In an aircraft, the throttle box allows the pilot to control the aircraft thrust whilst giving him tactile feedback to indicate various conditions or operating regimes of the engine, for example by providing mechanical detents for demarcation between distinct areas of operation such as dry and re-heat.

In many existing throttle boxes the force applied to the control member is detected and used to cause the control member to move in the appropriate direction. However, force feedback in these existing throttle boxes is provided by mechanical means. Mechanical systems are not dynamically programmable; detents, for example, are therefore static in such systems. Electronic force feedback systems have been developed; however, these are predominantly analogue. However, these exhibit the problem of long-term drift and have complex set-up procedures, with each device requiring individual set-up parameters. Motors and gearing or drive chains or belts are typically used to control the movement of the control member in such systems and to maintain the position of the control member at rest, preventing inadvertent movement of the control member by vibration or acceleration experienced by the aircraft in use. Gearing, chains and belts are, however, prone to backlash. Multiple motors have been used to reduce backlash. While it has been suggested that these systems can operate with the use of a single motor, the performance of such single motor systems is impaired by an even greater degree of backlash.

Accordingly, the present invention provides a control apparatus with force feedback comprising a movable control member, a positional servo loop consisting of a motor having a movable armature thereby maintaining the position of the control member at any one of a plurality of positions in a range of movement thereof in accordance with a demand signal, and means for measuring current applied to the motor for detecting a force applied to the control member and for providing the demand signal which varies in accordance with the magnitude of the applied force, wherein the control member is rigidly attached to the armature so that movement of the control member is precisely mirrored by movement of the armature.

This arrangement uses the motor current to measure the force applied (the current being proportional to the force). The direct drive of the control member eliminates the use of gearing, drive belts or chains and thereby eliminates backlash from the system. This eliminates chatter which prevents oscillation in the system. As the control member attachment to the motor armature is rigid, there is no possibility of drift over time and therefore the need for adjustments during the service life of the apparatus is also removed.

The control member may be directly attached to the motor armature.

Conveniently, the positional servo loop is electronic and digital in nature; there may also be an electronic force servo loop, also operating digitally. A digital servo system has a lower power consumption and produces less heat in operation than prior art analogue counterparts thereby leading to an extended lifetime of the apparatus.

The control apparatus may further comprise a pulse width modulator to convert an error signal resulting from the demand signal and the measured current (force) to a pulse train to drive each motor. Motor inductance is preferably used to integrate the pulse train into a current based on the error signal. Preferably the pulse train is a high frequency pulse train. Using pulse width modulation to drive the motor gives improved motor response at low speed and overcomes many of the problems of driving DC or stepper motors at low speed using traditional methods.

Preferably, the motor is linear and not a stepper variety. The linear motor may be in the form of a line, an annulus or an arc.

Advantageously, the control apparatus further comprises position sensing or encoding means (a “readhead”) for providing an output signal determined by the position of the control member.

The position sensing or encoding means may be non-contact, avoiding wear of the system.

The position sensing or encoding means may be a potentiometer or magnetic transducer.

Alternatively, the position sensing or encoding means is an optical encoder.

An optical encoder grating may be attached to or provided directly on the armature of the motor. The readhead may be mounted on the non-moving part, or the optical encoder grating may be attached to or provided directly on the non-moving part with the readhead mounted directly on the armature of the motor.

The means for detecting a force may further comprise means for monitoring a drive signal of the motor (such as the current demanded by the motor) to determine the force transmitted by the control member to the motor means.

The control apparatus may further comprise detent friction threshold means for locally thresholding the means for detecting a force at at least one predetermined location within the range of movement of the control member, whereby an applied force above the localised threshold is required to alter the position of the control member, thereby providing a detent effect.

Means responsive to the speed of movement of the control member may be provided to adjust each threshold level to provide a velocity damping effect. This allows the detent force to be increased such that the opposition of the detent to movement remains significant during ‘slams’ by the pilot.

Preferably, the control apparatus further comprises automatic control means responsive to a positional signal representative of the position of the control member and an externally-generated auto-control signal indicating a required position for the control member thereby to provide the demand signal for the positional servo loop, whereby in use the movable control member is caused to move to or maintain the required position.

There may be provided means for allowing dynamic re-programming of at least one of the detent and velocity damping characteristics of the control member. This provides the ability to re-program a single throttle box to replicate the exact feel and function of a variety of aircraft.

The invention will now be described by way of example and with reference to the accompanying drawings, in which:

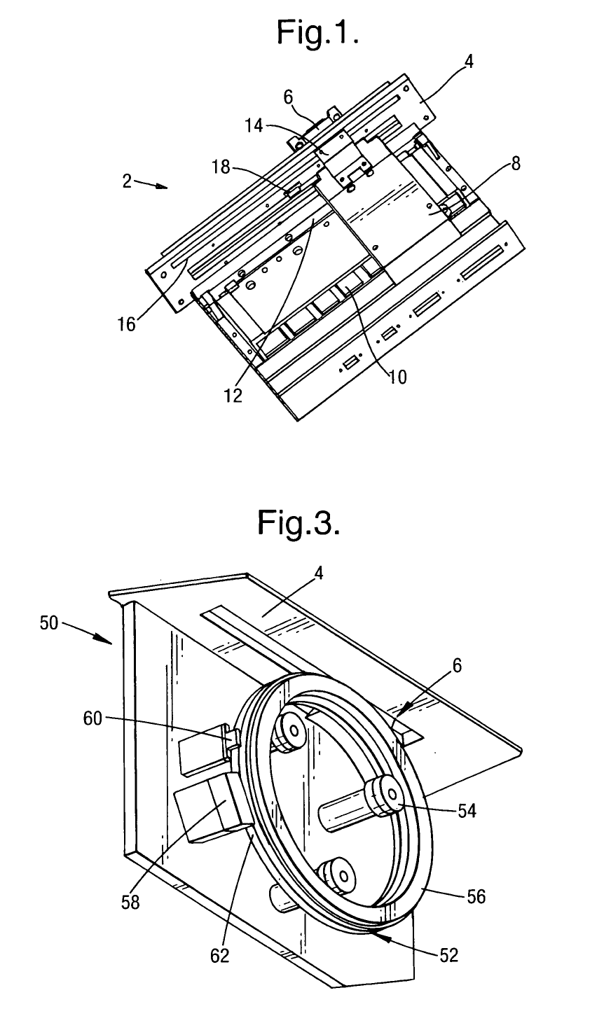

FIG. 1 is a schematic diagram of an embodiment of a control apparatus in accordance with the invention.

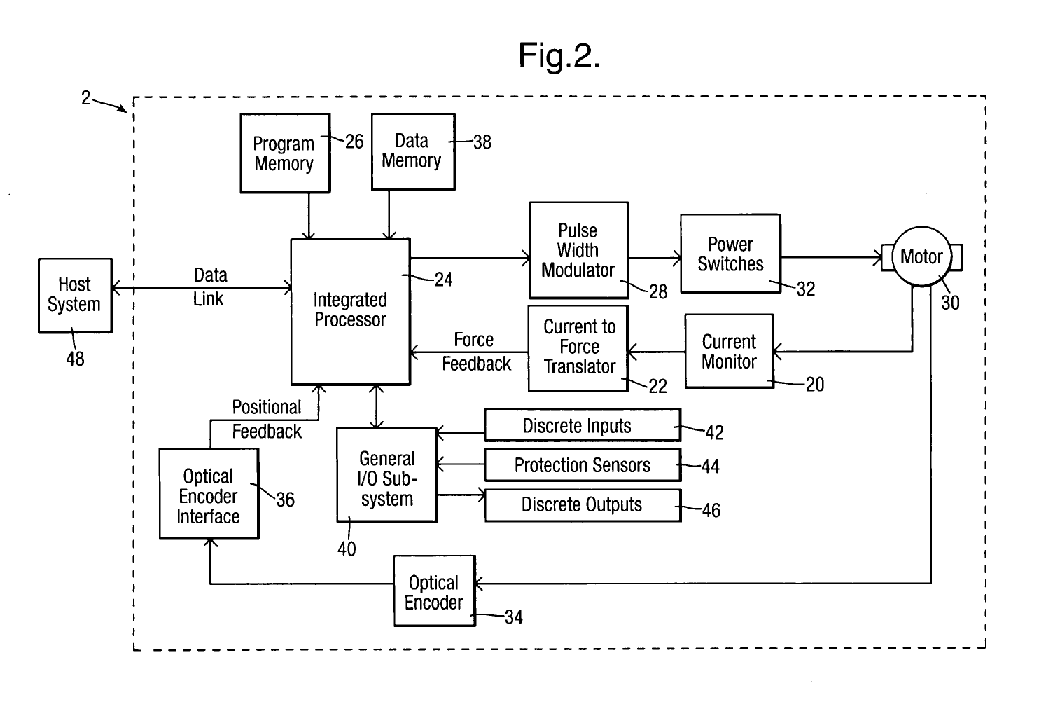

FIG. 2 is a schematic block diagram of the apparatus shown in FIG. 1.

FIG. 3 is a schematic diagram of another embodiment of a control apparatus in accordance with the invention.

FIG. 1 shows a throttle box 2 comprising a throttle box shell 4 and a movable control member 6 having an exposed manually grippable portion (not shown) which is constrained to move longitudinally. The control member 6 is rigidly attached to the armature 8 of a linear motor and a linear motor magnet track 10 is fixed to the throttle box shell 4. A linear guide 12 is provided, along which the motor armature 8 and control member 6 can slide.

When force is applied to the movable control member 6 the motor current increases. With reference to FIG. 2, a current monitor 20 measures the motor current which is related to the applied force. A current-to-force translator 22 converts the motor current data into a form suitable for the processor control loop. An analogue voltage is derived prior to an analogue-to-digital converter which may or may not be within the integrated processor 24. Program memory 26, which may or may not be integrated into the processor chip, contains the program instructions for the processor 24. The processor 24 executes the program stored in the program memory 26 to provide a demand signal to a pulse width modulator 28 which converts the motor drive demand into a mark-space pulse train suitable for driving the linear motor 30 with a high level of precision. At low speed the output pulses of the pulse width modulator 28 are narrow and at high speed the pulses are wide. The area under the pulse waveform curve, when integrated by the inductance of the motor, results in an effective speed control method. Pulse width modulation gives an improved motor response at low speed and overcomes many of the problems of driving motors at low speed using traditional methods. The use of a pulse width modulation technique reduces power requirements, significantly reducing the losses associated with traditional drive methods. Power switches 32 provide digital power amplification of the pulse width modulator pulse train to drive the motor 30.

As the motor armature 8 moves in response to the force applied to the control member 6, the position of the armature 8 and control member 6 is determined by an absolute or incremental optical encoder 34. Optical encoders typically utilise a transmitter-receiver set to count opaque lines of a grating and thus the motion increment. Absolute encoders provide information in the form of a unique output for every resolvable movement of motion. Incremental encoders provide a series of periodic signals due to motion, the number of signals corresponding to the resolvable increments of motion. A reference mark 18 is therefore required to zero counters in incremental optical encoders. Further reference marks may be used to denote end-of-travel limits of the movable control member 6. Returning to FIG. 1, an optical encoder readhead 14 is mounted on the motor armature 8; as the armature 8 moves, the optical encoder readhead 14 is translated past an optical encoder grating 16 attached to the throttle box shell 4. The optical encoder (34 in FIG. 2) thereby provides positional feedback, returning data to the integrated processor 24 defining the instantaneous actual position of the moving control member 6. Being optical in nature, the encoder 34 is a non-contact device having a long and reliable life. It also provides excellent repeatability and linearity due to its digital nature. An optical encoder interface 36 conditions the data provided by the optical encoder 34 into a form suitable for use by the processor 24.

A proportional-integral-differential (PID) servo control loop within the integrated processor 24 receives one input from the optical encoder interface 36 (position feedback) and another input from the current to force translator 22 (force feedback). The output of the PID servo control loop passes to the motor 30 to continue movement of the motor armature 8 until the armature 8 is in the required position given by the force applied to the control member 6. Once the difference between the actual position of the control member 6 and the required position, given by the force applied to the control member 6, is zero, the motor armature 8 stops moving.

Force profile data is stored in data memory 38 which may or may not be integrated into the processor chip. The profile data may be simple parameters used in algorithms in the processor 24 or may be force/position lookup tables. The data provides a position-dependent force threshold below which the applied force should be ignored. The threshold will typically vary from a base friction level throughout most of the range of movement of the control member 6 to one or more peaks of selected height to provide the equivalent of mechanical detents to give tactile feedback to the operator.

The PID servo control loop contains a velocity term which may be used to increase the friction threshold applied, for example, in regions of detent. Making the detent height a function of velocity of the control member 6 increases the forces generated when high rates of control member movement are applied. This is of particular significance in the region of a detent because it allows the detent force to be increased such that the opposition of the detent to movement remains significant during ‘slams’ by the pilot; mechanical arrangements suffer from the shortcoming that detents virtually disappear at high rates of travel.

A general input/output subsystem 40 provides signal-conditioning, for example input buffering, for any discrete inputs 42, protection sensors 44 or outputs 46 required. Protection sensors are used to determine an encoder reference datum and to define the limits of travel, moding switches and any indicators required for a specific variation. In this way, the force profile may be altered dynamically to adjust, for example, the level and position of the detents. This obviates the need for mechanical detents and reduces set up time of the apparatus. The ability to re-program a single throttle box to replicate, for example, the exact feel and function of a variety of aircraft, is useful in a flight simulator as it removes fixed costs associated with simulator refits. Flexibility in programming the system also allows replication of the latest aircraft throttle functions such as variable force profiles and detent positions during flight conditions.

The throttle box 2 is operable either manually or under automatic control where the position of the throttle control 6 is moved automatically in accordance with the signals produced by a computer on board the aircraft. A host system 48 provides the digital data link to the throttle box 2 and controls the demanded position in auto-throttle mode, in which the host system 48 moves the movable member 6 without pilot intervention. The host system 48 also provides force/position profile data, etc. and can provide updates dynamically.

FIG. 3 illustrates a rotary throttle box 50, an alternative throttle box comprising a throttle box shell 4 and a movable control member 6 having an exposed, manually grippable portion (not shown). The control member 6 is attached to a rotatable slide ring 52 which is supported and constrained in three dimensions by rotary V-bearings 54 situated on the inner circumference of the slide ring 52. Alternatively, the rotary V-bearings 54 may be positioned on the outer circumference of the slide ring 52. The rotor part 56 of a slab torque motor is attached directly to the slide ring 52. The stator of the motor, not shown in FIG. 3 for clarity, is attached to the throttle box shell 4 and positioned in a concentric manner relative to the rotor 56, on the inside or outside of the slide ring 52 or above the slide ring 52 and rotor 56. The rotor may be the field assembly and the stator the coil windings or vice versa. Adjustable hard stops (not shown) are provided to limit the range of travel of the control member 6 and within this range travel may also be limited by software-generated stops. An optical encoder readhead 58 and an encoder reference mark detector 60 is fixed to the throttle box shell 4 and an optical encoder grating 62 is applied to the edge of the slide ring 52.

The rotary throttle box 50 shown in FIG. 3 operates in a similar manner to the linear throttle box 2 illustrated in FIG. 1 and follows the general scheme set out in FIG. 2. Application of a force to the movable control member 6 causes the motor current to increase. A current monitor (20 in FIG. 2) measures the motor current and a current-to-force translator 22 converts the motor current data into a form suitable for the processor control loop. A processor 24 provides a demand signal to a pulse width modulator 28 which converts the demand into a pulse train suitable for driving the motor 56. Power switches 32 provide digital power amplification of the pulse width modulator pulse train to drive the motor 3O and move the rotor 56 relative to the stator. As the control member 6 moves, the slide ring 52 rotates, translating the optical encoder grating 62 past the optical encoder readhead 58. The optical encoder 34 is thereby used to provide feedback on the position of the control member 6. A PID servo control loop compares the actual position of the control member 6 to the required position given by the force applied to the control member 6; the output of the PID servo control loop passes to the motor to continue movement of the motor armature 56 until the armature 56 is in the required position given by the force applied to the control member 6. Once the difference between the actual position of the control member 6 and the required position is zero, the motor armature 56 stops moving.

Having now described various embodiments in accordance with the invention, numerous modifications will become apparent to the skilled person. The optical encoder may include an optical readhead attached to the motor armature or the slide ring or linear guide and a grating strip attached to or provided directly on the throttle box shell, for example by means of etching, stamping or painting. Alternatively, the grating strip may be attached to or provided directly on the motor armature and an optical readhead attached to the throttle box shell. The optical encoder may instead be a reflective system in which the grating is formed by segments of non-reflective space on a strip between reflective segments.

The encoder may alternatively utilise non-optical indexing means, such as magnetic indexing. The encoder may comprise a potentiometer or magnetic transducer.

The position sensing or encoding means may be of linear or rotary form. When in rotary format, the position sensing or encoding means may be placed on the inside or outside of the slide ring.

In the rotary throttle box described above, the slide ring may not comprise an annulus, rather it may comprise an arc.

Although all the embodiments are described as having one motor, which is advantageous for cost and weight reasons, it is possible for the control apparatus to comprise more than one motor, each motor being rigidly or directly attached to the control member.

It will be understood that detents may consist either of an increased or a reduced force threshold.

1. A control apparatus comprising a movable control member; a positional servo loop consisting of a motor having a movable armature thereby maintaining the position of the control member at any one of a plurality of positions in a range of movement thereof in accordance with a demand signal, and means for measuring current applied to the motor for detecting a force applied to the control member and for providing the demand signal which varies in accordance with the magnitude of the applied force, wherein the control member is rigidly attached to the armature so that movement of the control member is mirrored by movement of the armature.

2. A control apparatus according to claim 1 further comprising a force servo loop wherein the positional and force servo loops are electronic and operate on a digital basis.

3. A control apparatus according to claim 1, further comprising a pulse width modulator to convert an error signal resulting from the demand signal and the measured current to a pulse train to drive the motor, motor inductance means being provided to integrate the pulse train into a current based on the error signal.

4. A control apparatus according to claim 1, wherein the motor is linear.

5. A control apparatus according to claim 1, further comprising position sensing or encoding means for providing an output signal determined by the position of the control member.

6. A control apparatus according to claim 5 wherein the position sensing or encoding means is non-contact.

7. A control apparatus according to claim 5, wherein the position sensing or encoding means is a potentiometer or magnetic transducer.

8. A control apparatus according to claim 5, wherein the position sensing or encoding means is an optical encoder.

9. A control apparatus according to claim 8 wherein an optical encoder grating is attached to or provided directly on the armature of the motor.

10. A control apparatus according to claim 1, further comprising detent friction threshold means for locally thresholding the force detection means at at least one predetermined location within the range of movement of the control member, whereby an applied force above the localised threshold is required to alter the position of the control member, thereby providing a detent effect.

11. A control apparatus according to claim 10 further comprising means responsive to the speed of movement of the control member to adjust each threshold level to provide a velocity damping effect.

12. A control apparatus according to claim 1, wherein the means for detecting a force further comprises means for monitoring a drive signal of the motor to determine the force transmitted by the control member to the motor.

13. A control apparatus according to claim 1, further comprising automatic control means responsive to a positional signal representative of the position of the movable control member and an externally-generated auto-control signal indicating a required position for the control member thereby to provide the demand signal for the positional servo loop, whereby in use the control member is caused to move to or maintain the required position.

14. A control apparatus according to claim 10, further comprising means for allowing dynamic reprogramming of at least one of the friction threshold and velocity damping characteristics of the control member.
